(19) United States
(12) Patent Application Publication
(10) Pub. No.: US 2023/0104527 A1
(43) Pub. Date: Apr. 6, 2023

(54) ELECTRIC SMOKER

(71) Applicant: NINGBO AGSUN PRODUCTS, INC., CIXI (CN)

(72) Inventors: Xuefei Mao, CIXI (CN); Liangbin Zuo, CIXI (CN); Xianghua Liu, CIXI (CN)

(73) Assignee: NINGBO AGSUN PRODUCTS, INC., CIXI, ZJ (CN)

(21) Appl. No.: 18/076,436

(22) Filed: Dec. 7, 2022

(30) Foreign Application Priority Data
Oct. 13, 2022 (CN) 202222705772.8

(51) Int. Cl. A23B 4/052

(52) U.S. Cl. CPC A23B 4/052; A23V 2002/00

(57) ABSTRACT

The disclosure provides an electric smoker, comprising a box body, an inner housing and a controller, one side of box body is provided with a box door, a smoking device is mounted in inner housing, the controller is mounted on the box body for controlling the smoking device, the inner housing is arranged in the box body, an opening of the inner housing faces the box door, a water collection cavity located below the controller is formed on inner housing, water collection cavity comprises an inner concave surface arranged obliquely toward the controller, an outer wall of the inner housing is provided with a water collection groove structure and a guide groove structure, water collection groove structure is connected to a lower end of the inner concave surface, and an outflow port of the guide groove structure is connected to an inflow port of the water collection groove structure.

### TECHNICAL FIELD

The disclosure pertains to the technical field of smokers, and specifically pertains to an electric smoker.

### BACKGROUND

Smoking is a process of smoking food without complete combustion of fuel to change tastes of products, improve their quality and extend their shelf lives. Main functions of smokers are to cook, dry and smoke food, and users can change different fumeols to change smoked flavors of the food.

When an existing electric smoker is used, on-off switching of functions can be realized by a controller. For example, grant publication No. CN214483054U discloses a dual-purpose electric smoker which comprises a smoker body and a storage cabinet arranged at a lower end of the smoker body; the smoker body comprises a box body, a barbecue mechanism, a smoking frame, a smoking mechanism, a first heating tube, a second heating tube and an air outlet assembly; the smoking frame is arranged in the box body, the barbecue mechanism is arranged at an upper end portion of an inner side of the box body, and the barbecue mechanism is located above the smoking frame; the first heating tube is arranged above the barbecue mechanism in the box body, the second heating tube is arranged at a lower end portion of the inner side of the box body, the smoking mechanism is arranged at a lower side of an inner side wall of the box body, and the air outlet assembly is arranged on a box body wall of the box body; and one side of the box body is provided with a smoker door capable of being opened and closed, and an upper end side wall of the box body is provided with a numerical control module for controlling the first heating tube and the second heating tube.

However, most of the existing numerical control modules of the electric smokers are controllers. When the electric smoker works outdoors, if raining occurs, rainwater easily flows into the interior of the box body from a gap between the box body and the controller, so that water enters the food during the smoking process, water accumulation occurs in the box body, and oil accumulation occurs on the accumulated water surface, affecting user experience.

### SUMMARY

The object of the disclosure is to design an electric smoker in order to solve the above-mentioned technical deficiencies, collect and guide rainwater seeping into a box body, and discharge rainwater seeping into the box body, so as to effectively avoid the problems of water accumulation, water ingress and oil accumulation in the electric smoker, and improve user experience.

In order to solve the above-mentioned technical problems, the technical scheme of the disclosure is as follows: an electric smoker comprises a box body, an inner housing and a controller, one side of the box body is provided with a box door, a smoking device is mounted in the inner housing, the controller is mounted on the box body for controlling the smoking device, the inner housing is arranged in the box body, an opening of the inner housing faces the box door, a water collection cavity located below the controller is formed on the inner housing, the water collection cavity comprises an inner concave surface arranged obliquely toward the controller, an outer wall of the inner housing is provided with a water collection groove structure and a guide groove structure, the water collection groove structure is connected to a lower end of the inner concave surface, and an outflow port of the guide groove structure is connected to an inflow port of the water collection groove structure.

Preferably, the smoking device comprises a heating tube and a fumeol case, the heating tube is electrically connected with the controller, the heating tube is located below the fumeol case, a cover plate is detachably connected to a top of the fumeol case, the cover plate is provided with a plurality of smoking holes therethrough, and an inner wall of the inner housing corresponding to an upper part of the cover plate is provided with a plurality of grilling net pieces.

Preferably, the heating tube is of an annular tube structure, a bottom surface of the fumeol case covers the heating tube, an oil collection tray is provided at bottoms of the grilling net pieces near the cover plate, and the oil collection tray covers the fumeol case.

Preferably, a bottom of the inner housing is provided with a water collection tray, one side of the water collection tray is provided with a water guide channel, the box body is provided with an insertion hole therethrough for inserting the water guide channel, a bottom of the box body is provided with an oil collection case, and an opening of the oil collection case faces the water guide channel.

Preferably, an outflow port of the water collection groove structure communicates with the water guide channel, the inflow port of the water collection groove structure is provided with an upper cover water collection plate, and the guide groove structure comprises two oppositely arranged folded edges, the two folded edges are located at a bottom of the upper cover water collection plate and are arranged obliquely toward the inflow port of the water collection groove structure.

Preferably, the box door corresponding to a side wall of the inner housing is provided with a door water collection plate, and the door water collection plate is arranged obliquely toward the water collection tray.

Preferably, a first rear sealing plate and a second rear sealing plate are detachably connected to a side wall of the box body close to the oil collection case, the first rear sealing plate positionally corresponds to the water collection cavity, the second rear sealing plate positionally corresponds to the heating tube, and both the first rear sealing plate and the second rear sealing plate are provided with a plurality of air holes therethrough.

Preferably, a mounting hole is provided through a top surface of the box body, a fixing bracket is detachably connected in the mounting hole, the controller is detachably connected to the fixing bracket, one side of the fixing bracket is provided with an insert, an inner hole wall of the mounting hole is provided with a slot for insertion of the insert, and the other side of the fixing bracket is detachably connected to the first rear sealing plate.

Preferably, both the first rear sealing plate and the second rear sealing plate are sheet metal pieces, and inner hole walls of the air holes are formed by stamping and are bent downwards.

Preferably, the inner wall of the inner housing is provided with a side extraction support plate for slip connection of the fumeol case, the side extraction support plate is located above the heating tube, and both the box body and the inner housing are provided with a movable hole therethrough for movement of the fumeol case.

Compared with the prior art, the disclosure has the following beneficial effects: when the electric smoker is in an outdoor raining environment, rainwater enters the box body through a connection gap between the controller and the box body, the outer wall of the inner housing can block the rainwater, the water collection cavity plays a role of collecting and guiding the rainwater entering the box body, and the rainwater in the water collection cavity flows through the guide groove structure and the water collection groove structure successively by gravity, and is discharged to the outside through the outflow port of the water collection groove structure, preventing water accumulation in the electric smoker, effectively avoiding the problems of water accumulation, water ingress and oil accumulation in the electric smoker, and improving user experience.

### BRIEF DESCRIPTION OF THE DRAWINGS

FIG. 1 is a schematic structural diagram I of an embodiment;

FIG. 2 is a schematic structural diagram II of the embodiment;

FIG. 3 is a schematic structural diagram of the embodiment with a box door opened;

FIG. 4 is an exploded view of a box body, a fixing frame and a controller;

FIG. 5 is a schematic structural diagram of an inner housing; and

FIG. 6 is a cross-sectional view of FIG. 5.

Reference numerals in the drawings: 1. box body; 2. inner housing; 3. controller; 4. box door; 5. door lock; 6. heating tube; 7. fumeol case; 8. cover plate; 9. smoking hole; 10. grilling net piece; 11. oil collection tray; 12. water collection tray; 13. water guide channel; 14. insertion hole; 15. oil collection case; 16. water collection cavity; 17. water collection groove structure; 18. upper cover water collection plate; 19. guide groove structure; 20. external power cord; 21. exhaust cover; 22. exhaust vent; 23. through hole; 24. door water collection plate; 25. hook piece; 26. hanging hole; 27. first rear sealing plate; 28. second rear sealing plate; 29. air hole; 30. side extraction support plate; 31. movable hole; 32. mounting hole; 33. fixing bracket; 34. insert; 35. slot; 36. roller.

### DESCRIPTION OF THE EMBODIMENTS

The disclosure will be further described in the following examples with reference to the accompanying drawings.

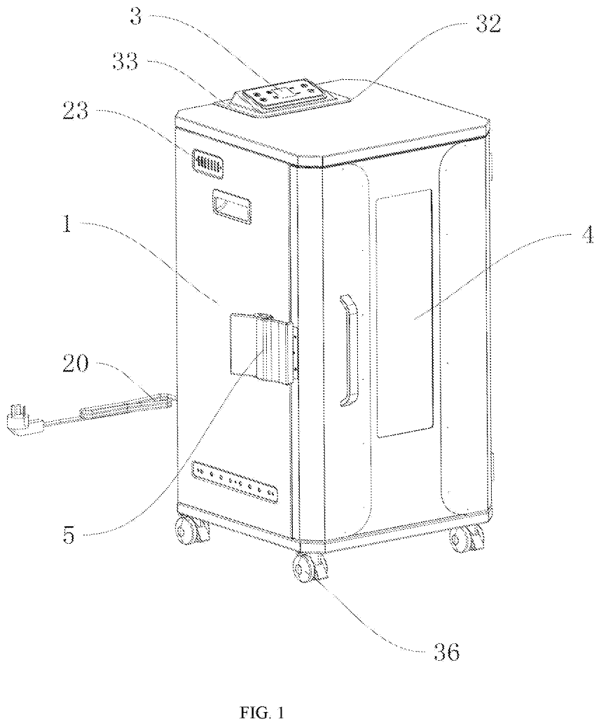

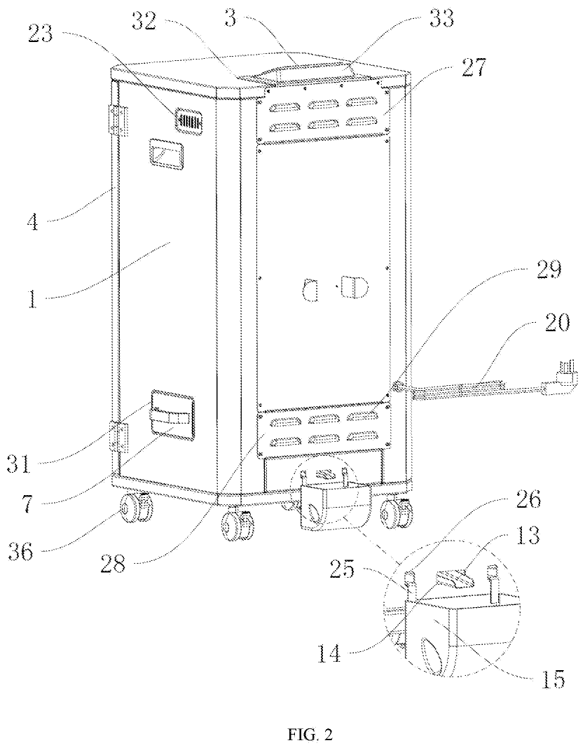

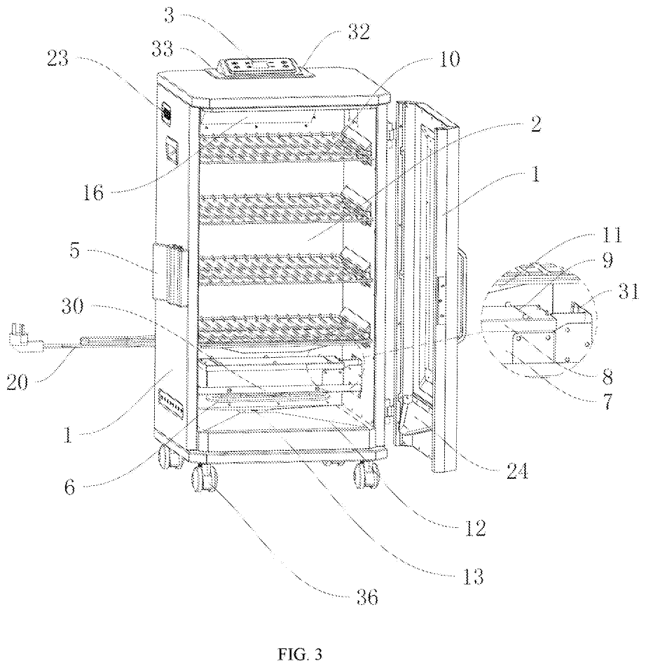

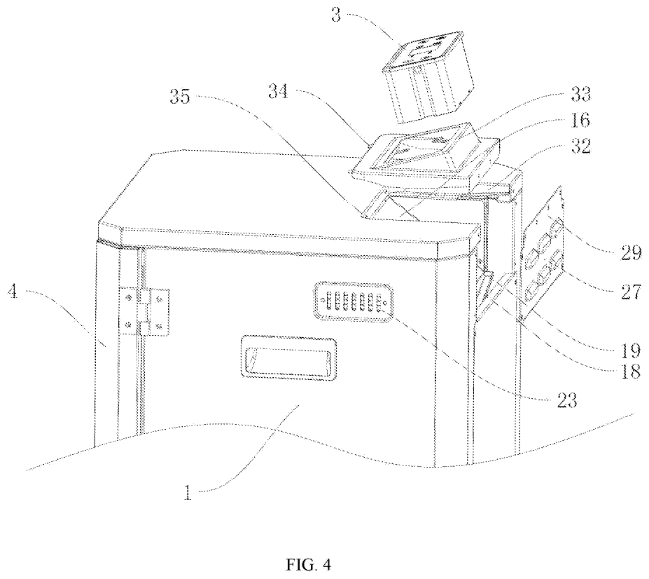

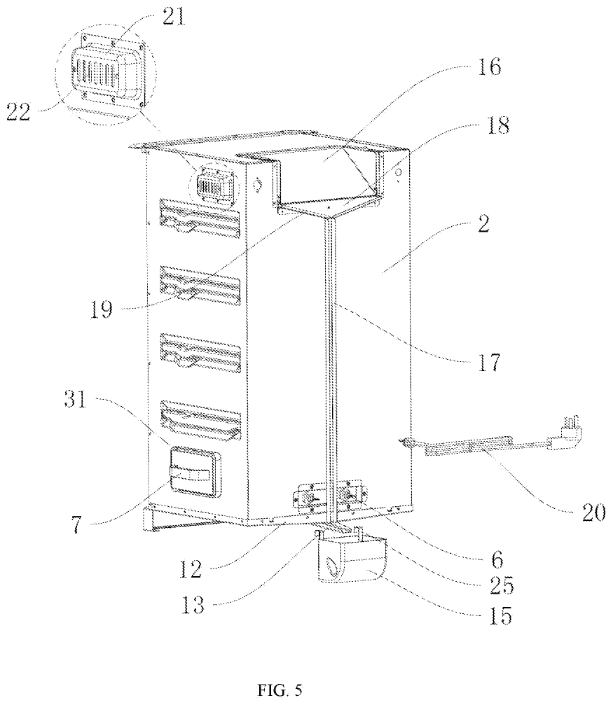

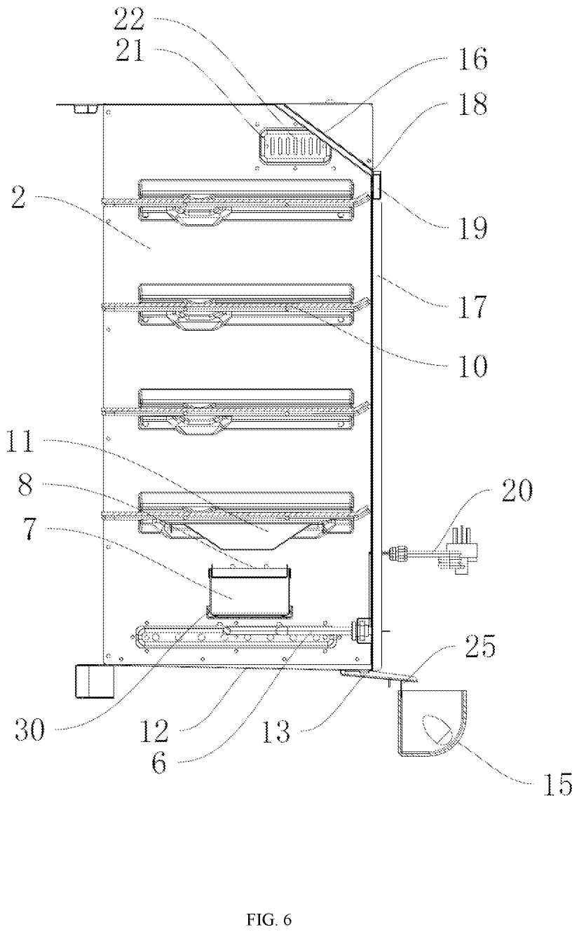

With reference to FIGS. 1 to 6, an electric smoker comprises a box body 1, a controller 3 and an inner housing 2, one side of the box body 1 is provided with a box door 4, one side of the box door 4 is hinged to an opening of the box body 1, the other side of the box door 4 is provided with a door lock 5, and a user can lock the box door 4 closed by means of the door lock 5, four rollers 36 are uniformly provided around a bottom of the box body 1, the rollers 36 each have a braking function, and the rollers 36 are used for supporting the box body 1 and facilitating the user to move the electric smoker.

The controller 3 is detachably connected to a top surface of the box body 1, the inner housing 2 is arranged in the box body 1, and an opening of the inner housing 2 faces the box door 4; a smoking device is arranged in the inner housing 2, and the smoking device comprises a heating tube 6 and a fumeol case 7; the controller 3 is a circuit system on the electric smoker for controlling operation of electric appliance, which is prior art, and will not be described in detail herein; and the heating tube 6 is electrically connected to the controller 3, and the user can control the start and stop of the heating tube 6 outside the box body 1 by the controller 3.

The heating tube 6 is located below the fumeol case 7; an inner wall of the inner housing 2 corresponding to an upper part of the fumeol case 7 is provided with a plurality of grilling net pieces 10, and the plurality of grilling net pieces 10 are uniformly distributed in a height direction of the inner housing 2; and a cover plate 8 is detachably connected to a top of the fumeol case 7, the cover plate 8 is provided with a plurality of smoking holes 9 therethrough, and the user can remove the cover plate 8, place fumeols into the fumeol case 7 and ignite them, and then cover the cover plate 8. When the electric smoker is used to smoke food, the box door 4 is opened, the food is respectively placed on the plurality of grilling net pieces 10, and then the box door 4 can be closed. The box body 1 is provided with an external power cord 20 for connecting to a power supply to provide energy for the electric smoker. After the electric smoker is powered on, the user starts the heating tube 6 by the controller 3; the heating tube 6 converts electric energy into heat energy by heating wires to heat an inner cavity of the inner housing 2 and the fumeol case 7, so that smoke from burning of the fumeols in the fumeol case 7 is discharged from the smoking holes 9 and enters the inner cavity of the inner housing 2 for smoking the food placed on the grilling net pieces 10.

The heating tube 6 is of an annular tube structure, the heating tube 6 is covered on a bottom surface of the fumeol case 7; and an oil collection tray 11 is detachably connected to bottoms of the grilling net pieces 10 close to the cover plate 8, and the oil collection tray 11 covers the fumeol case 7. A bottom of the inner housing 2 is provided with a water collection tray 12, one side of the water collection tray 12 is provided with a water guide channel 13, the water collection tray 12 is an inner concave plate, a lower end of the inner concave plate communicates with the water guide channel 13, the box body 1 is provided with an insertion hole 14 therethrough for inserting the water guide channel 13, the bottom of the box body 1 is provided with an oil collection case 15, an opening of the oil collection case 15 faces the water guide channel 13, two hanging holes 26 are respectively provided through two sides of the box body 1 corresponding to the insertion hole 14, a top of the oil collection case 15 is symmetrically provided with two hook pieces 25, and the hook pieces 25 are inserted into the corresponding hanging holes 26; the oil collection case 15 is suspended at the bottom of the box body 1 through inserted connection of the hook pieces 25 and the hanging holes 26, and the user lifts the oil collection case 15 to drive the hook pieces 25 until the hook pieces 25 completely match the hanging holes 26, and the user can detach the hook pieces 25 from the hanging holes 26 so as to remove and clean the oil collection case 15.

In the process of smoking the food by the electric smoker, the food on the grilling net pieces 10 is roasted out grease under a high temperature environment, the fumeol case 7 can prevent the grease from dripping to the heating tube 6 for burning, the oil collection tray 11 collects the grease roasted out from the food on the grilling net pieces 10, and when the grease in the oil collection tray 11 overflows due to excess, since the oil collection tray 11 covers the fumeol case 7, the overflowing grease directly drips onto the water collection tray 12 without passing through the fumeol case 7 and the heating tube 6, preventing the smoking hole 9 from being blocked by the grease and food residues, and ensuring that the smoke from the fumeol case 7 is discharged.

A water collection cavity 16 is formed at a top of the inner housing 2 corresponding to the controller 3, the water collection cavity 16 comprises an inner concave surface arranged obliquely toward the controller 3, an outer wall of the inner housing 2 is provided with a water collection groove structure 17, a water outlet of the water collection groove structure 17 communicates with the water guide channel 13, an upper cover water collection plate 18 is arranged between a bottom of the water collection cavity 16 and a top of the water collection groove structure 17, the upper cover water collection plate 18 is a sheet metal piece, both sides of a bottom of the upper cover water collection plate 18 are bent and provided with folded edges, the two folded edges are arranged obliquely toward an inflow port of the water collection groove structure 17, and the two folded edges form a guide groove structure 19.

The grease roasted from the food drips onto the water collection tray 12, and flows through the water guide channel 13 and is collected into the oil collection case 15. If the electric smoker is in an outdoor raining environment, rainwater enters the box body 1 through a connection gap between the controller 3 and the box body 1, the outer wall of the inner housing 2 can block the rainwater from contacting with the food; the water collection cavity 16 plays a role of collecting and guiding the rainwater entering the box body 1; the rainwater in the water collection cavity 16 flows through the guide groove structure 19 and the water collection groove structure 17 successively along the upper cover water collection plate 18 by gravity, and flows from an outflow port of the water collection groove structure 17 into the water guide channel 13; and the rainwater and the grease are introduced into the oil collection case 15 through the water guide channel 13, effectively avoiding the problems of water accumulation, water ingress and oil accumulation in the electric smoker and improving user experience.

An exhaust cover 21 is formed on the top of the inner housing 2, a plurality of exhaust vents 22 are provided through the exhaust cover 21, a through hole 23 corresponding to the exhaust vents 22 is provided through the box body 1, and the smoke from the inner wall of the inner housing 2 can be discharged to the outside of the box body 1 through the exhaust vents 22 and the through hole 23, which facilitates removal of steam from the food when the food is smoked and roasted and plays a certain pressure reduction function, ensuring that the smoke flows in the inner housing 2 and fully contacts with the food.

The box door 4 corresponding to a side wall of the inner housing 2 is provided with a door water collection plate 24, and the door water collection plate 24 is arranged obliquely toward the water collection tray 12. During the use of the electric smoker, the box door 4 is closed so that the inner cavity of the inner housing 2 is in a relatively closed environment; when water and oil in the smoking are condensed into water droplets and oil droplets, the water droplets and the oil droplets on an inner cavity wall of the inner housing 2 flow onto the water collection tray 12 by gravity, both side portions of the door water collection plate 24 are bent to guide the water droplets and the oil droplets, and the water droplets and the oil droplets on an inner wall of the box door 4 collect and flow onto the water collection tray 12 under the guidance of the door water collection plate 24, avoid flowing out from a connection between a bottom of the box door 4 and the box body 1.

A first rear sealing plate 27 and a second rear sealing plate 28 are detachably connected to a side wall of the box body 1 close to the oil collection case 15, the first rear sealing plate 27 positionally corresponds to the water collection cavity 16, the second rear sealing plate 28 positionally corresponds to the heating tube 6, and both the first rear sealing plate 27 and the second rear sealing plate 28 are provided with a plurality of air holes 29 therethrough to assist in discharging excess hot air in the box body 1. Both the first rear sealing plate 27 and the second rear sealing plate 28 are sheet metal pieces, and inner hole walls of the air holes 29 are formed by stamping and bent downwards, so that the first rear sealing plate 27 and the second rear sealing plate 28 ventilate and dissipate heat while have a rainproof function.

The inner wall of the inner housing 2 is provided with a side extraction support plate 30 for slip connection of the fumeol case 7, the side extraction support plate 30 is located above the heating tube 6, and both the box body 1 and the inner housing 2 are provided with a movable hole 31 therethrough for movement of the fumeol case 7. The side extraction support plate 30 is used for side extraction of the fumeol case 7. When the user needs to make up the fumeols, the user can directly extract the fumeol case 7 without opening the box door 4, and remove the cover plate 8 to replace the fumeols, which effectively reduces heat and smoke loss caused by replacement of the fumeols, and ensures the smoking flavor to the maximum extent.

A mounting hole 32 is provided through the top surface of the box body 1, a fixing bracket 33 is detachably connected in the mounting hole 32, the controller 3 is detachably connected to the fixing bracket 33, one side of the fixing bracket 33 is provided with an insert 34, an inner hole wall of the mounting hole 32 is provided with a slot 35 for insertion of the insert 34, and the other side of the fixing bracket 33 is detachably connected to the first rear sealing plate 27. The controller 3 is disassembled on the box body 1 by the fixing bracket 33; inserted connection of the insert 34 and the slot 35 guides a worker to mount the fixing bracket 33 in the mounting hole 32 at a correct position; then mount the first rear sealing plate 27 on the box body 1, and connect the fixing bracket 33 to the first rear sealing plate 27 to avoid detachment of the insert 34 from the slot 35 to complete mounting of the controller 3. The user also can remove the first rear sealing plate 27 from the box body 1 to take out the fixing bracket 33 and the controller 3, so as to replace and maintain the controller 3.

Of course, the above describes typical embodiments of the disclosure only. In addition, the disclosure can also have various other implementations, and all technical schemes formed by equivalent replacement or equivalent transformation fall within the scope of protection of the disclosure.

What is claimed is:

1. An electric smoker, comprising a box body, an inner housing and a controller, wherein one side of the box body is provided with a box door, a smoking device is mounted in the inner housing, the controller is mounted on the box body for controlling the smoking device, the inner housing is arranged in the box body, an opening of the inner housing faces the box door, a water collection cavity located below the controller is formed on the inner housing, the water collection cavity comprises an inner concave surface arranged obliquely toward the controller, an outer wall of the inner housing is provided with a water collection groove structure and a guide groove structure, the water collection groove structure is connected to a lower end of the inner concave surface, and an outflow port of the guide groove structure is connected to an inflow port of the water collection groove structure.

2. The electric smoker according to claim 1, wherein the smoking device comprises a heating tube and a fumeol case, the heating tube is electrically connected with the controller, the heating tube is located below the fumeol case, a cover plate is detachably connected to a top of the fumeol case, the cover plate is provided with a plurality of smoking holes therethrough, and an inner wall of the inner housing corresponding to an upper part of the cover plate is provided with a plurality of grilling net pieces.

3. The electric smoker according to claim 2, wherein the heating tube is of an annular tube structure, a bottom surface of the fumeol case covers the heating tube, an oil collection tray is provided at bottoms of the grilling net pieces near the cover plate, and the oil collection tray covers the fumeol case.

4. The electric smoker according to claim 3, wherein a bottom of the inner housing is provided with a water collection tray, one side of the water collection tray is provided with a water guide channel, the box body is provided with an insertion hole therethrough for inserting the water guide channel, a bottom of the box body is provided with an oil collection case, and an opening of the oil collection case faces the water guide channel.

5. The electric smoker according to claim 4, wherein an outflow port of the water collection groove structure communicates with the water guide channel, the inflow port of the water collection groove structure is provided with an upper cover water collection plate, and the guide groove structure comprises two oppositely arranged folded edges, the two folded edges are located at a bottom of the upper cover water collection plate and are arranged obliquely toward the inflow port of the water collection groove structure.

6. The electric smoker according to claim 4, wherein the box door corresponding to a side wall of the inner housing is provided with a door water collection plate, and the door water collection plate is arranged obliquely toward the water collection tray.

7. The electric smoker according to claim 4, wherein a first rear sealing plate and a second rear sealing plate are detachably connected to a side wall of the box body close to the oil collection case, the first rear sealing plate positionally corresponds to the water collection cavity, the second rear sealing plate positionally corresponds to the heating tube, and both the first rear sealing plate and the second rear sealing plate are provided with a plurality of air holes therethrough.

8. The electric smoker according to claim 7, wherein a mounting hole is provided through a top surface of the box body, a fixing bracket is detachably connected in the mounting hole, the controller is detachably connected to the fixing bracket, one side of the fixing bracket is provided with an insert, an inner hole wall of the mounting hole is provided with a slot for insertion of the insert, and the other side of the fixing bracket is detachably connected to the first rear sealing plate.

9. The electric smoker according to claim 7, wherein both the first rear sealing plate and the second rear sealing plate are sheet metal pieces, and inner hole walls of the air holes are formed by stamping and are bent downwards.

10. The electric smoker according to claim 2, wherein the inner wall of the inner housing is provided with a side extraction support plate for slip connection of the fumeol case, the side extraction support plate is located above the heating tube, and both the box body and the inner housing are provided with a movable hole therethrough for movement of the fumeol case.
